(19) United States
(12) Patent Application Publication
(10) Pub. No.: US 2006/0085480 A1
(43) Pub. Date: Apr. 20, 2006

(54) Human resource sourcing exchange

(76) Inventors: Michael Veronesi, Marietta, GA (US); David Krier, Marietta, GA (US); Fredric Stockfield, Smyrna, GA (US)

Correspondence Address: SIROTE & PERMUTT, P.C., P.O. BOX 55727, 2311 HIGHLAND AVENUE SOUTH, BIRMINGHAM, AL, 35255-5727, US

(21) Appl. No.: 11/254,840

(22) Filed: Oct. 20, 2005

Related U.S. Application Data
(60) Provisional application No. 60/620,534, filed on Oct. 20, 2004.

(51) Int. Cl. G06F 17/00

(52) U.S. Cl. 707/104.1

(57) ABSTRACT

A human resources sourcing exchange system includes a seeker interface and an agent interface so that human resource employees may submit positions that recruiting agents can use to submit candidates for employment for that position. The HR employee may associate a single fee to a plurality of agents payable to the agent that provides an incentive for candidate hiring. The system resides on a computer server and provides multiple simultaneous access to users over a local or global communications network, such as the Internet, for employee agents and employee seekers, such as the HR employee, to exchange employment information. The system structures the process through a series of HTML screens whereby such agents and seekers can exchange employee candidates and employee positions, which results in a facilitated matching of resources.

This application claims the benefit of filing priority under 35 U.S.C. §119 and 37 C.F.R. §1.78 of the co-pending U.S. Provisional Application Ser. No. 60/620,534 filed Oct. 20, 2004, for a Human Resources Marketing Program. All information disclosed in the prior pending provisional application is incorporated herein by reference.

### FIELD OF THE INVENTION

The present invention relates generally to a method of performing human resource functions within an organization. More particularly, the invention relates to performing candidate searches for employment through a network of agents.

### BACKGROUND OF THE INVENTION

Human resource professionals confront a Hobson's choice when deciding how to advertise a position within the organization. Either the position may be posted for all to view, such as through an online career board service like Monster.com or Hotjobs, or, limit access to a much smaller subsection of candidates by hiring a person such as an executive recruiter to find and fill the position. Choosing to post the position on a career board results in an unfiltered, massive candidate pool of candidates who are at best marginally qualified for the position. There is little control over the quality of candidates whose resumes are received. Moreover, because positions are posted by both organizations that are looking for individuals and executive recruiters who have been hired to find candidates, the same job may have multiple entries within the same career board service. Thus, an organization that is searching for a candidate may review the same resume multiple times.

In the alternative, choosing an executive recruiter limits the candidate pool to the applicants known to the individual recruiter and her network. Such a limited group of individuals may limit the quality of the candidates reviewed. Thus, the breadth of the search is limited. Moreover, the fee charged by the recruiter is usually fixed by the recruiter and does not reflect the value of the position to the organization attempting to fill the position.

Finally, within the organization, the human resources department may drain the resources in that organization. In most situations, the human resources department does not conduct the business of the organization. Instead, the department fits the specific needs of the organization. However, there may be times when a candidate who is very qualified for similar positions may not be a good fit within the organization. In such a situation, the human resources department, has no incentive to help that candidate find a position within a different organization.

### SUMMARY OF THE INVENTION

It is an object of the invention to provide a method of finding an employee by aggregating agents of employable candidates. A talent seeker specifies a fee for the service of an agent simultaneously to a plurality of agents. The seeker posts a position listing characteristics sought in an employable candidate. Candidates are reviewed by the seeker after the agents submit the candidates. The seeker employs a reviewed candidate and pays the fee to the agent who submitted the candidate.

It is another object of the invention to provide a method of finding employment for a candidate. The method includes reviewing posts of positions listing characteristics sought for an employee. The characteristics are matched to a candidate's abilities. The candidate is notified that the candidate's abilities match a post. The candidate is submitted to a seeking agent. A fee set forth in the post is collected after the candidate becomes an employee of the seeking agent.

Another object of the invention is to provide a system for matching candidates with an employment opportunity. A seeker interface is configured to receive and post a fee amount and characteristics of an employment opportunity to a plurality of agents. An agent interface is configured to search the posted employment opportunities and submit candidates who meet the characteristics of the employment opportunity. The posted fee is paid to an agent through the agent interface when the agent submits a candidate that becomes employed by the seeker.

### BRIEF DESCRIPTION OF THE DRAWINGS

FIG. 1 is a block diagram of a human resources sourcing exchange system for facilitating employment decisions.

FIG. 2 is a block diagram of a seeker interface shown in FIG. 1.

FIG. 3 is a block diagram of an agent interface shown in FIG. 1.

FIG. 4 is a flow chart of the steps a seeker takes in posting and hiring a candidate for a position.

FIG. 5 is a flow chart of the steps an agent takes in finding a position and matching a candidate to an employment opportunity.

FIG. 6 is a flow chart of the steps within the human resources sourcing exchange system of FIG. 1 to facilitate the exchange of positions and candidates between the agent and seeker.

FIG. 7 is a partial example of an innovator interface showing positions, transactions, and candidates.

FIG. 8 is another partial example of an innovator interface showing candidate activity.

FIG. 9 is another partial example of an innovator interface showing details about a candidate.

FIG. 10 is another partial example of an innovator interface showing details about a position.

### DESCRIPTION OF THE PREFERRED EMBODIMENTS

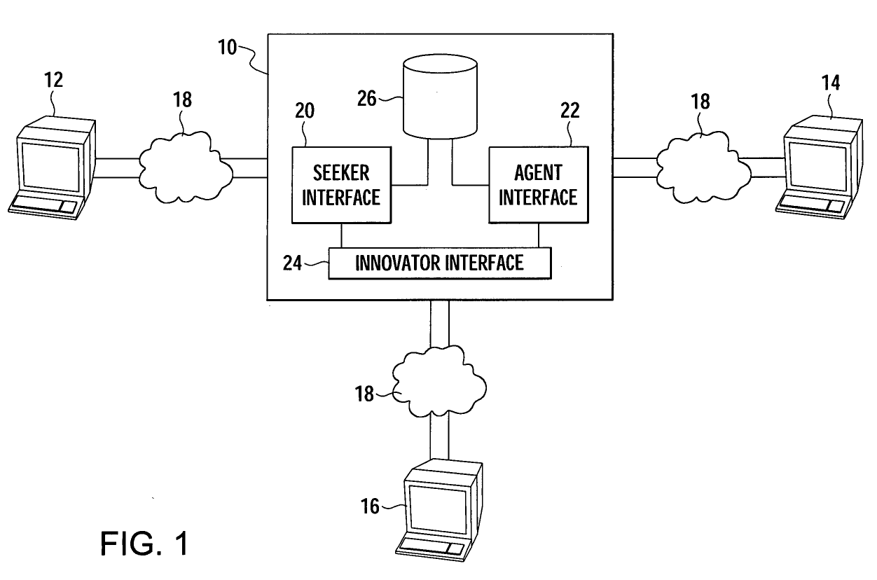

Turning now to the drawing figures, FIG. 1 is a block diagram of a system 10 for facilitating employment decisions. The system 10 initiates communications between users such as a seeker 12, a talent agent 14, and an innovator 16 through networks 18, such as the Internet. Each type of user initiates contact to the system by logging on, which initiates a specific user interface determined by the access the user has established within the system 10. The seeker 12 initiates activity through a seeker interface 20. The talent agent 14 initiates activity through an agent interface 22. An innovator interface 24 combines both the seeker interface 20 and the agent interface 22 so that an innovator 16 may use the system 10 as either a seeker 12 or a talent agent 14. A database 26 stores the information that the users enter into the system 10.

The system 10 is preferably a website residing on a server available to users through a web browser program such as Microsoft Internet Explorer or Firefox. Preferably, the interfaces 20, 22, and 24 are built using hyper-media pages. Such browsers interpret received hyper-media pages, often called hyper-text pages, and present a formatted visible page on a computer screen to a user pursuant to the wishes of the page's author. Hyper-media pages are currently written in HTML (HyperText Markup Language) version 4.0, or later, but the inventors fully anticipate that later versions of HTML will be created to enhance the user's Internet experience. For the purposes of the present disclosure, the term “hyper-media” is defined as any type of HTML page file presently available or hereafter developed, or similar language, that presents linked text and objects to a user over the Internet or other communications networks. Through such hyper-media pages, scripts can be written in applications such as Omnipilot Lasso to verify data and control the input and output of data into SQL databases 26. As such, the database 26 is structured to receive the input related to the seekers 12, talent agents 14, innovators 16, employment opportunities submitted by seekers 12 and candidates submitted by agents 14 such that server side applications can access the information to display results on the client-side display. Additional workflow applications, as described below, are triggered from input operations. For example, the system 10 can produce and send emails to users and candidates when certain triggers from events occur.

In operation, a seeker 12 enters the site, preferably over a network such as the Internet, to post a position for employment on the system 10. The seeker 12 preferably enters the site through a personal computer. A seeker 12 may be a human resources manager at a corporation, or a person otherwise responsible for filling the employee needs of an organization. Through the seeker interface 20 a seeker 12 may add a position to the database 26. The seeker 12 may also manage previously entered positions and review the candidates that have been submitted to fill the positions the seeker 12 has posted.

Once a seeker 12 posts a position, agents 14 may enter the system and review the position posted. An agent 14 may be a recruiter, such as an executive recruiter. In this manner, agents 14 are not people seeking an employment possibility for themselves, but instead are searching for employment opportunities for others. In the system 10, then, the agent 14 is responsible for directing a candidate toward an open position. Such a system 10 allows a seeker 12 to expect agents 14 to only submit candidates that are qualified for the position posted. The candidates submitted by the agents 14 would be more qualified because, first, the agents 14 are more likely to understand the needs posted by the seeker 12, and second, poor submittals by an agent 14 would likely mean that seekers 12 would likely spend less time reviewing the candidates from the agent 14 who provides poor candidates.

Finally, the third type of user, an innovator 16, combines the functionality of both a seeker 12 and an agent 14. Such a user may be a member of a human resources department. As an innovator 16, a user may post positions in the system 10 as a seeker 12 and also provide candidates to other seekers 12 as an agent 14. By posting positions, the innovator 16 hopes to attract candidates from other agents 14 who may have access to candidates the innovator 16 has not seen. As an agent 14, the innovator 16 may review the postings of other seekers 12 and provide candidates to the seekers 12 that the innovator 16 has met through other channels, such as internal candidates within the organization or candidates who had sought employment at the innovator's organization through other means.

As an example, a human resources department may want to become a profit center within the organization. In most situations, HR departments are considered loss centers within an organization. The department provides necessary services, but is rarely responsible for adding value to the organization through providing the services or products that the organization uses to generate revenue. With the system 10, though, the human resources department can generate revenue by providing assistance to candidates who initially are searching for a position within the organization, but do not meet the needs of the organization. If such a candidate meets the needs of a seeker 12 in the system 10, then the innovator 16 may submit the candidate to the seeker 12. In doing so, the innovator 16 has used the system 10 to provide the service of an agent 14 to a seeker 12.

As another example, the same innovator 16 may be asked to deal with a situation in which employees have been laid off. In order to help the displaced employees, the innovator 16 may review the positions posted in the system 10. By using the system 10 in this manner allows an innovator 16 to rebuild a part of the relationship between the displaced employee and the innovator's organization.

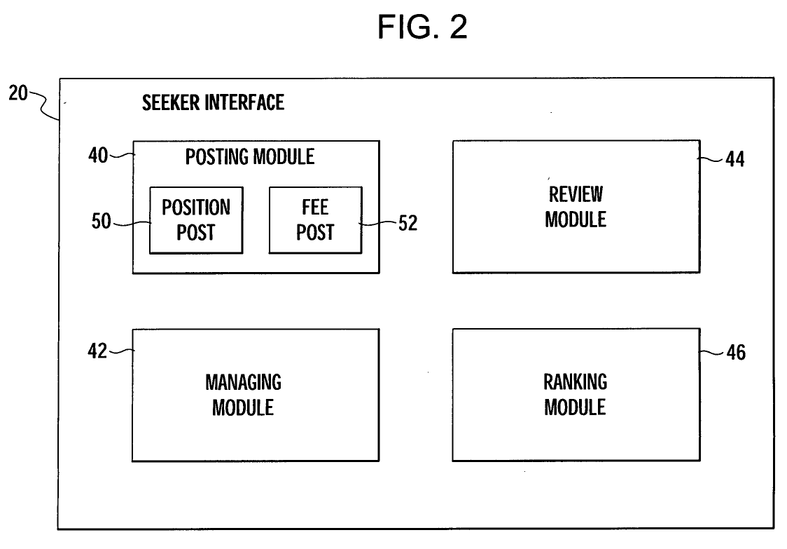

Turning now to the next figure, FIG. 2 is a block diagram of the seeker interface 20 shown in FIG. 1. The seeker interface 20 preferably includes a plurality of modules including a posting module 40, a managing module 42, a review module 44, and a ranking module 46. The posting module 40 includes a position post tool 50 and a fee post tool 52. Within the posting module 40, the position post tool 50 is the interface for adding a position to the system 10. The seeker 12 may post preferred characteristics of a candidate, minimum qualifications for the position, or both so that agents 14 may better search their candidates for the seeker 12.

The fee posting tool 52 allows the seeker 12 to set the fee for the position. The fee is the amount of money the seeker 12 will pay an agent 14 who provides the candidate who ultimately becomes an employee of the seeker's organization. By setting their own fee, a seeker 12 provides the same fee to all agents 14. Thus, the organization does not need to consider different fee structures for different agents 14 when they consider candidates. Moreover, by setting the fee, a seeker 12 can create more interest from agents 14 by setting the fee relatively high. In contrast, if the position is not as necessary or is not time sensitive, a seeker 12 may set a relatively low fee and hope a candidate eventually shows up for the position. In this manner, a seeker 12 has greater control over the flow of candidates into the seeker's account.

Once positions are posted, the seeker 12 will respond to agents 14 through the managing module 42 so that the agent 14 may inquire about the position or possible candidates the agent 14 wishes to submit. The seeker 12 may also bar certain agents 14 from seeing the position through the managing module 42. The managing module 42 may also be used to manage multiple positions if the seeker 12 has posted multiple positions. Finally, the managing module 42 may also be used to change the characteristics or the fee associated with a position.

Once candidates are submitted for a position, the seeker 12 uses the review module 44 to review the candidates. The candidate's resumes are posted to the seeker 12 through the review module 44. The seeker 12 may update the status of the process with the candidate within the review module 44. Ultimately, the final entry in the review will be either a rejection or an employment offer. The seeker 12, though, may hold a candidate while he interviews other candidates because he is still interested in that candidate and wants to keep the candidate and the candidate's agent interested in the position.

Another module in the seeker interface 20 is the ranking module 46. The ranking module 46 allows a seeker 12 to rate the quality of the candidates an agent 14 submits for the position. If an agent 14 submits poor quality candidates, then the seeker 12 is likely to give the agent 14 a poor ranking. The poor ranking may be used by the seeker 12 or other seekers to limit access of the agent 14 to the postings of the seeker 12. The ranking module 46, then, can further help to reduce the number of candidates submitted by using only those agents 14 who understand the needs of the seeker 12 and submit quality candidates to the seeker 12.

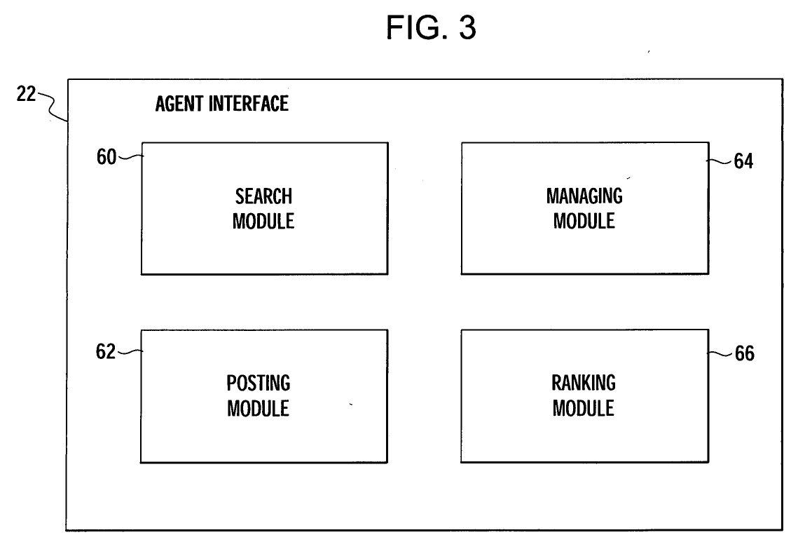

Turning now to the next figure, FIG. 3 is a block diagram of the agent interface 22 shown in FIG. 1. The agent interface 22 preferably includes a search module 60, a posting module 62, a managing module 64, and a ranking module 66. The search module 60 allows an agent 14 to search the postings of positions submitted by seekers 12. The search module allows an agent 14 to search through the job postings, and also allows the agents 14 to view the fees for each position. Once the agent 14 finds a match between a position and a candidate, then the agent uses the posting module 62 to submit a candidate.

The posting module 62 displays an interface between the agent 14 and the seeker 12. The agent 14 enters the posting module 62 and chooses a specific position to submit a candidate. The posting module 62 allows the agent 14 to send a candidate to the seeker 12. Preferably, before the agent 14 submits the candidate, the agent 14 must verify that the candidate meets the minimum qualifications for the position. Also, the agent 14 must certify that the candidate is not a candidate that was sent to the agent 14 by another agent. Once the agent 14 submits the candidate, the agent 14 can review the progress of the candidate through the managing module 64.

The managing module 64 of the agent interface 22 provides an interface in which an agent 14 can review candidates, check the status of submitted candidate, edit existing candidates and add new candidates. Through the managing module 64, the agent 14 is able to manage all aspects of the agent's candidates. For example, if a candidate has changed career goals, the agent 14 may add notations within the system that lets the agent 14 know what goals the candidate has. Other information in the candidate's biography are the essential elements that are submitted to the seeker 12 when submitting a candidate. In this manner, some information within the candidate's entry may be passed on to the seeker 12 while other information specific to the agent 14 may remain private to the agent 14, such as the contact info for the candidate.

Like the managing module 42 of the seeker interface 20, the managing module 64 of the agent interface 22 allows the user to update the status of the interaction between the seeker 12 and the candidate. If the seeker 12 wishes to ask questions regarding the candidate to the agent 14, a status message may appear in the managing module 64 with an entry that the seeker 12 has asked a question, and the agent may then answer the question and further update the status by submitting a status message that the question was answered. Thus, an agent 14 may use the managing module 64 to manage the day to day concerns within any transaction as well as manage candidate files. Once the transaction has completed, like the ranking module 46 of the seeker interface 20, the ranking module 66 of the agent interface 22 is configured to accept rankings from agents 14.

The rankings module 66 for agents allows agents to enter rankings for seekers 12. The rankings module 66 may also allow the agent 14 to submit notes regarding the seeker 12 so that in future transactions, the agent may remember any particular procedures or requirements in the process for submitting candidates to that seeker 12. Also, the ranking module 66 allows the agent 14 to rank the speed at which the seeker 12 performs tasks, such as review candidates, make offers, and pay fees. Such information is useful to the agent 14 as the agent 14 continues to interact with the seeker 12. In this manner, both the agent 14 and seeker 12 can continue to build a relationship through the system 10. Within the system 10, the agent interface 22 and the seeker interface 20 are the engines for creating the sourcing exchange. Turning now to the process of creating this exchange, the following figures describe the steps the users and the system follow in a transaction.

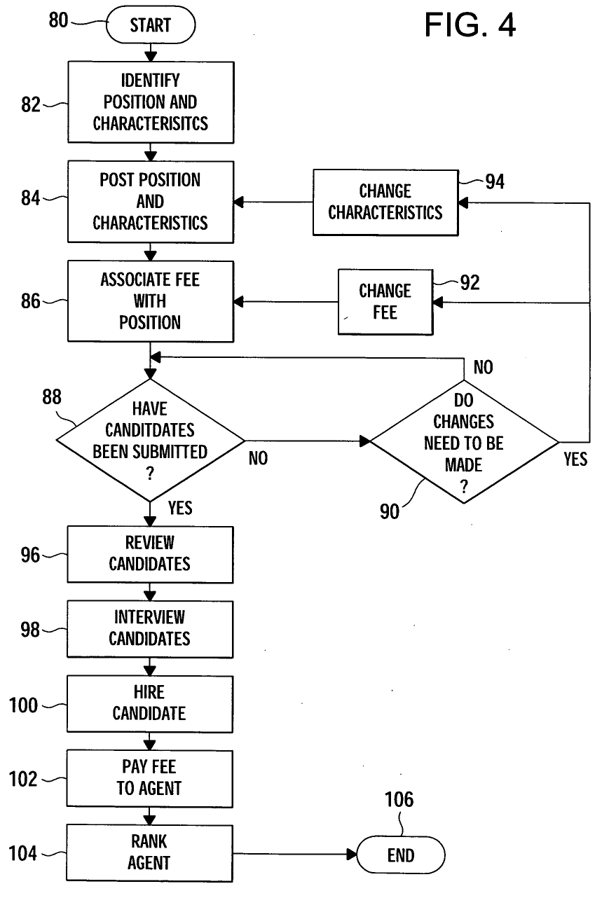

Turning to the next figure, FIG. 4 is a flow chart of the steps the seeker 12 takes in posting and hiring a candidate for a position. The method begins in step 80. A position and characteristics for that position are identified in step 82. In step 84, the position and the characteristics are posted. A fee is associated with the position in step 86. The method then waits for candidates to be submitted in step 88. If no candidates are submitted, then to the seeker 12 may make changes to the post in step 90. The fee may be changed in step 92, or the desired characteristics for the position may be changed in step 94. By changing the characteristics, such as the offered salary, the seeker 12 may create candidate submittals from agents 14. By changing the fee, the seeker 12 may encourage agents 14 to search harder for a match.

Once a candidate has been submitted in step 90, the seeker 12 reviews the candidate in step 96. A suitable candidate may be interviewed in step 98 and hired in step 100. Once the candidate becomes an employee of the seeker's organization, then the seeker 12 pays the fee specified in step 86 to the agent 14 in step 102. The seeker 12 ranks the agent 14 in step 104 and the method ends in step 106.

By implementing this method, the seeker 12 may be able to adjust the fee paid to any agent 14 by adjusting the fee in step 86. Thus, a seeker 12 may monitor the position and determine if the fee offered should be increased to generate more candidate submittals or lowered if too many candidate referrals are being submitted. Moreover, having a single fee associated with the position allows the seeker 12 to fix the cost of finding an employee among all agents instead of working within the individual agreements of many different agent agreements. Preferably, the fee is submitted within the system 10 and the system 10 may then disburse the fee to the agents 14. In this manner, a seeker 12 who uses the system 10 to employ many candidates may submit a single disbursement to pay for the fees associated with multiple positions.

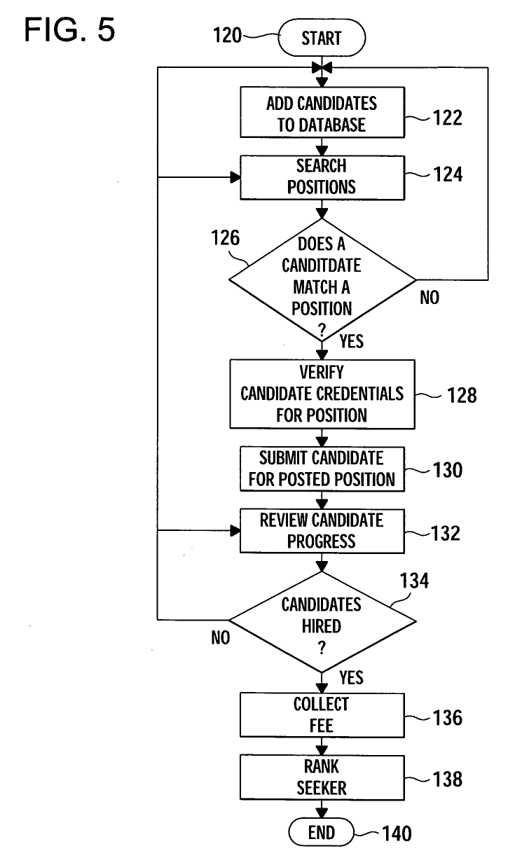

Turning to the next figure, FIG. 5 is a flow chart of the steps an agent takes in finding a position and matching a candidate to an employment opportunity. The method begins in step 120. An agent 14 adds candidates to the system in step 122 which are held in a confidential listing accessible only by the agent 14. The agent may search positions posted by seekers in step 124. When searching, the agent 14 determines in step 126 whether a position matches a candidate. If the candidates do not match a position, then the agent 14 continues to add candidates and search positions until a match is found.

When a match is found, the agent 14 verifies the credentials of the candidate in step 128. Once the agent 14 verifies the match, the agent 14 submits the candidate for the position in step 130. The agent 14 reviews progress of the candidate in step 132 and awaits a hiring decision in step 134. If no hiring decision is made, the agent 14 continues to review the progress and may also submit additional candidates by returning to step 122 of the method. Similarly, if the candidate is rejected, then the agent 14 may submit additional candidates by returning to step 122 of the method.

Once a decision to hire a candidate of the agent 14 is made, the agent 14 collects the fee set by the seeker 12 through step 136. In step 138, the agent 14 ranks the seeker 12 based on the transaction that has been completed, and the method ends in step 140. Through the agent interface 22, an agent may progress within the stated method for any number of different candidates, and any number of different positions. If the agent 14 has a particularly qualified candidate, he may submit that candidate to multiple positions. Similarly, if a position is broad enough that many of the agent's candidates meet the characteristics of the position, the agent 14 may submit multiple candidates to the seeker 12. Thus, an agent 14 may manage multiple candidates and/or multiple positions at the same time within the human resources sourcing exchange system.

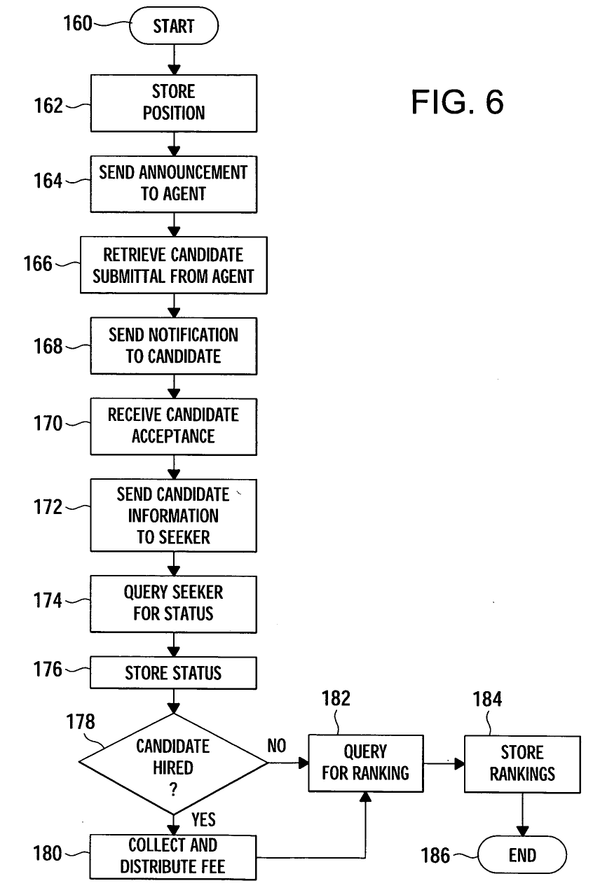

Moreover, while seekers 12 may manage multiple positions and agents 14 may manage multiple candidates at the same time, an innovator 16 may manage both multiple positions and multiple candidates at the same time. The innovator 16, accessing both the agent interface 22 and the seeker interface 20, may manage a plurality of transaction both as a seeker 12 and as an agent 14. Within the context of FIGS. 5 and 6, then, an innovator 16 may manage multiple instances of each of the methods, and may be at different steps in the multiple instances of the methods at any given time. Thus, the managing modules 42 and 64 of the interfaces 20 and 22, are preferably available simultaneously through the innovator interface 24 so that the innovator 24 may manage candidates and positions without having to change interfaces.

Turning to the next figure, FIG. 6 is a flow chart of the steps within the human resources sourcing exchange system 10 of FIG. 1 to facilitate the exchange of positions and candidates between the agent 12 and seeker 14. The method starts in step 160. A position for employment is stored in step 162. In step 164, an announcement announcing the position may be generated in the system and sent to agents 14. In step 166, candidate submittals from agents 14 are received based on the candidates the agent 14 has confidentially stored in the human resources sourcing exchange system 10. Once a candidate has been submitted, the human resources sourcing exchange system 10 notifies the candidate that the agent 14 has submitted the candidate for a position within the human resources sourcing exchange system 10 in step 168. The candidate then notifies the system that he accepts the submittal and the system receives the acceptance in step 170. Step 172 sends the candidate information to the seeker 12.

Once the candidate information has been submitted to the seeker 12, the human resources sourcing exchange system 10 may query the seeker (e.g., by an email) for the status of the candidate in step 174. When the seeker responds, the status is stored in step 176. The status may be continued review, a hold on the candidate, or a hiring decision. Once a decision regarding employment has been made, that decision is sent to the human resources sourcing exchange system 10 in step 178. If the applicant is hired, then the fee is collected and distributed to the agent 14. Once the fee is collected, or if the candidate is rejected, then the human resources sourcing exchange system 10 queries both the agent 14 and seeker 12 for a ranking of the other party in step 182. The rankings are stored in step 184 and the method ends in step 186.

As may be understood, the steps of FIG. 6 may also take place for many candidates and many positions at the same time. If multiple candidates are submitted for one position, then when a decision is made to hire one candidate, the status of the other candidates will be updated without additional entries by the seeker 12. Thus, within the context of one instance of the steps shown in FIG. 6, if steps 178 or 180 occur for one candidate, that is, a candidate is hired and a fee is collected, other agents of submitted candidates are notified.

Notifications and announcements from the system 10 may be sent to the agents 14, seekers 12, and candidates by email or other means of communication. The agent 14 and seeker 12 may have the same information from the notifications and announcements available to them in the human resources sourcing exchange system 10, but the candidate preferably receives the information through email or through direct contact (e.g., a telephone call) with the agent 14 or seeker 12. The candidate generally responds by selecting an appropriate html link presented to them in an email which in turn transmits an appropriate signal back to the system's server via the Internet.

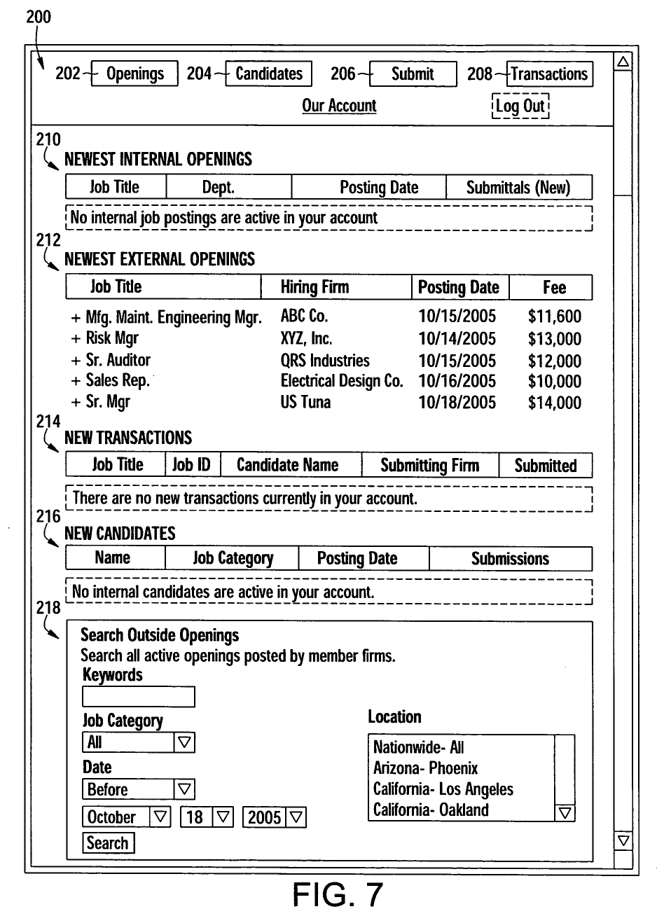

Turning to the next figure, FIG. 7 is a partial example of an innovator interface display summarizing positions, transactions, and candidates. A navigation bar 200 at the top of the interface 24 displays links to other pages within the interface 24. The other pages include an openings page 202, a candidates page 204, a submittal page 206, and a transactions page 208. Other pages such as a support (help) page, desktop (home) page, account information page, and log out page may also be accessible in the navigation bar 200. The display of the interface 24 may display summary activity according to type of posting such as internal positions 210 (or openings), external positions 212, new transactions 214, and new candidates 216. The innovator interface 24 may also provide search dialog fields 218.

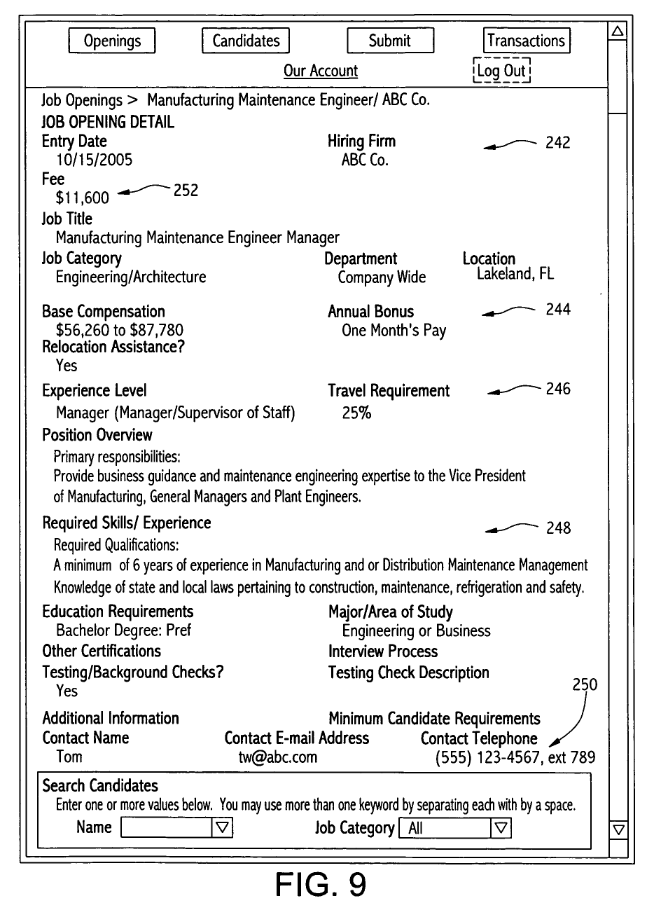

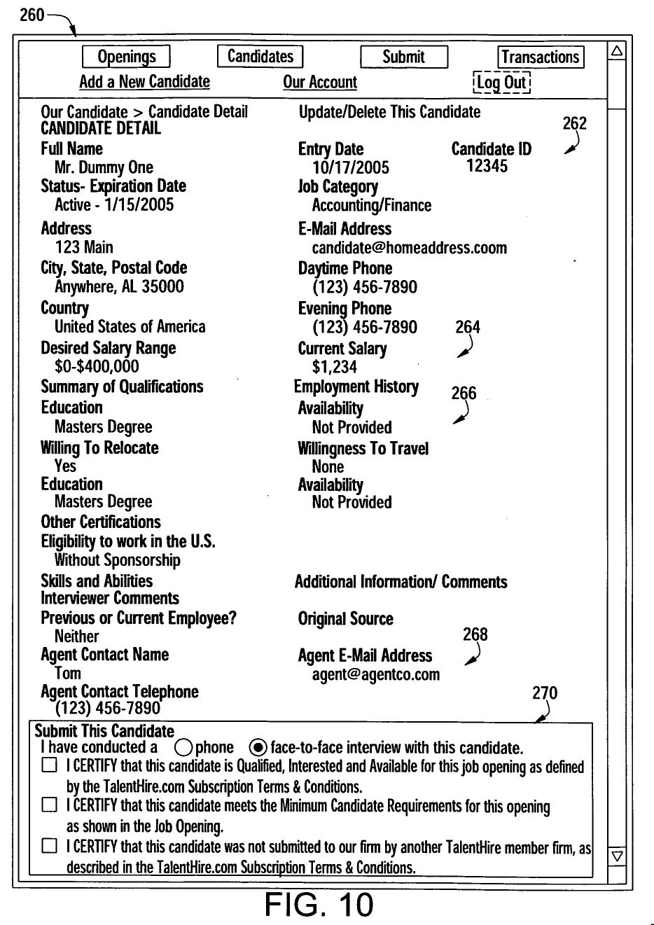

Each of the posting types 210-216 may have identifiers, and be hyperlinked to a details page as shown in FIGS. 9 and 10. The summary page of FIG. 7 provides enough information in summary so that an innovator 16 may review recent activity and determine which transactions, candidates, or positions need attention. Because this example interface is an innovator interface 24, both the summary displays for a seeker 12 and an agent 14 are shown in the innovator summary. A seeker 12 who is looking for a candidate to fill a position, would only use summaries for the internal positions 210 and the new transactions 214. The agent 14 would only use summaries of external positions 212, new transactions 214, and new candidates 216. The agent 14 may also use the search dialog fields 218.

Each page within the innovator interface 24 may use one or more of the modules in the seeker interface 20 or agent interface 22. While the modules described above with reference to FIGS. 2 and 3 are functional modules of the interfaces 20 and 22, the displays of FIGS. 7-10 show results of the input and output functions of one or more of the modules. For example, the summary page for an agent 14 displays external positions according to date. The search module 60 of the agent interface 22 runs a search within the database 26 to find the newest external positions to display to the summary of external positions 212. The summary of new transactions 214 uses the managing module 64 to query the database 26 for the most recent transactions posted within the agent's account. The search dialog 218 allows an innovator 16 (or an agent 14) to create a search through the search module 60. Thus, the modules represent the functional aspects of the system 10 while the displays represent the manifestation of the results of those modules, or dialog boxes to provide the necessary input to those modules to produce results within the displays.

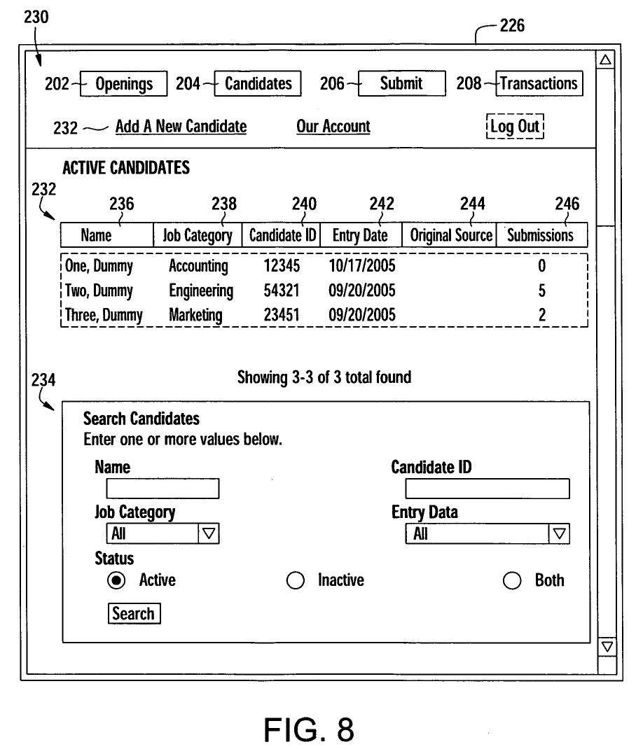

Turning to the next figure, FIG. 8 is another partial example of an innovator interface showing a candidate display 226. A navigation bar 230 includes many of the same hyperlinks as shown in FIG. 7. The commonality of the navigation bars in different displays allows a user a reference for navigating the displays. Additional links such as an add a new candidate link 232 are specific to the display.

The candidate display 226 includes an active candidates display 232 and a candidate search dialog 234. The active candidates display 232 lists the name 236, category 238, ID number 240, entry date 242, source 244 and submissions 246. Each of these categories are filled by records from the database 26 and displayed to the agent 14 or innovator 16 when the user is viewing their candidates. The submissions category 246 is a count of the number of times a candidate has been submitted for different positions. Thus category may be helpful, for example, in determining when a candidate should re-exam his goals, or when an agent should reconsider the characteristics presented in the candidate detail.

The candidate search dialog 234 can only search the candidates of the agent 14 or innovator 16. As such, the candidate search dialog 234 performs functions within the managing module 64. The function of the candidate search dialog 234 allows a user with many candidates to limit the list of active candidates within the candidate display 226. While the candidate search dialog shown in this example, and the other examples of search dialogs, uses a small subset of characteristics in the search functions, it is understood that any attribute or characteristic may be used in search dialog fields. As can be seen in the following figures, the characteristics of both candidates and positions include many characteristics.

When an agent 14 is viewing the position display, the agent 14 may submit a candidate by clicking the submit button in the navigation bar. When the submit button is clicked the candidate display 226 of FIG. 8 is displayed. After an agent 14 clicks one of the candidates on the candidate display 226, the system 10 retrieves the profile of the candidate, which is shown in FIG. 10, and associates that candidate temporarily with the position the agent 14 was viewing. The candidate, though, is not submitted to the seeker 12 for the position displayed until the agent completes the submittal as described below with respect to FIG. 10.

Turning to the next figure, FIG. 9 is another partial example of an innovator interface 24 showing details about a position. A position opening detail 240 lists specific data about a job opening. The data fields include summary information 242 such as job title, category, hiring company department and location; compensation information 244 such as base compensation, bonuses, and relocation assistance; position overview 246 which may include experience level, travel requirements, and a position overview; qualifications 248 such as required skills and experience, education, certifications, and major; contact information 250, and a fee 252.

Depending on the type of user, the data within the position opening detail 240 may be displayed or may be empty. The data within the position opening detail 240 is displayed when an agent 14 or an innovator 16 acting as an agent searching external positions is searching the system 10 for positions for candidates. However, when the user is a seeker 12 or an innovator 16 acting as a seeker 12 by posting positions, the data is empty and input fields are shown below each data field. When a seeker 12 adds a new position, the seeker 12 is queried for data such as compensation information 244, position overview 246, qualifications 248 and fee 252. The information may be queried through text boxes, drop down boxes, check boxes or the like. Some of the information such as contact information 250 and portions of the summary information 242 are generated from the date and user information generated from login to the system 10. Thus, the input into the database 26 and the output from the database 26 include the same fields to make searching easier.

Turning to the next figure, FIG. 10 is another partial example of an innovator interface showing details about a candidate. A candidate display 260 includes general candidate information 262, salary requirements 264, qualifications 266, agent contact information 268, and certification 270. The general candidate information 262 may include specifics about the candidate such as name, home address, and contact information. The salary requirements 264 may list desired salary and current salary. The qualifications 266 may list the qualifications of the candidate such as education, work history and skills. The agent contact information 268 may list the contact information for the candidate's agent so that a seeker 12 who has received the candidate through the agent's submittal may contact the agent 12 to discuss the candidate.

Similar to FIG. 9, depending on the type of user, the data within the candidate display 260 may be displayed or may be empty. The data within the candidate display 260 is displayed when a seeker 12 or an innovator 16 acting as a seeker to fill a position is reviewing a candidate submitted by an agent 14. However, when the user is an agent 14 or an innovator 16 acting as an agent by posting candidates, the data is empty and input fields are shown below each data field. When an agent 14 adds a new candidate, the agent 14 is queried for data such as portions of the general candidate information 262, salary requirements 264, qualifications 266, and certification 270. The information may be queried through text boxes, drop down boxes, check boxes or the like. Some of the information such as agent contact information 268 and portions of the general candidate information 262 are generated from the date and user information generated at login to the system 10. For the same reasons as above, the input into the database 26 and the output from the database 26 include the same fields makes searching easier.

Unlike FIG. 9, the candidate display 260 further includes certification 270. The certification 270 requires an agent 14 when he submits a candidate to verify the candidate is qualified and interested in the position, meets the minimum qualifications, and was not submitted by another user of the system 10 to the agent 14. The certification box 270 only appears when an agent 14 is attempting to submit a candidate to a seeker 12. When an agent 14 is submitting a candidate, all other information about the candidate will be supplied from the database 26, as the agent had previously entered the candidate data when adding the new candidate initially. Thus, as shown in FIG. 10, one instance of the candidate display 260 for the agent 14 includes displayed information from the database 26 and empty data in the certification box 270 because an agent 14 is not able to certify that the candidate meets the qualifications of the position until the agent 14 has reviewed the position. Thus, for each position an agent 14 wishes to submit the candidate, the agent 14 must check the certification boxes 270 each time.

While the invention has been shown in embodiments described herein, it will be obvious to those skilled in the art that the invention is not so limited but may be modified with various changes that are still within the spirit of the invention.

Having set forth the nature of the invention, what is claimed is:

1. A method of finding an employee by aggregating agents of employable candidates, comprising the steps of:
a. specifying a fee for the service of an agent simultaneously to a plurality of agents connected through a network;
b. inputting a position listing characteristics sought in an employable candidate through a computer;
c. reviewing computer generated forms displaying candidates submitted by networked agents;
d. employing a reviewed candidate; and
e. causing the payment of the fee to the agent who submitted the candidate.

2. The method of claim 1, wherein the fee is paid through the network using an SSL protocol.

3. The method of claim 1, wherein the agent is a human resources employee of a company whose primary business purpose is not placing candidates into employment.

4. The method of claim 3, wherein the submitted candidate initially sought employment at the company of the human resources employee.

5. The method of claim 1, wherein the characteristics are minimum qualifications.

6. The method of claim 5, further comprising the step of requiring the agent to verify the candidate meets the minimum qualifications.

7. The method of claim 6, further comprising the step of requiring the agent to certify that the candidate was not submitted to the agent by another agent to whom the fee was specified.

8. The method of claim 1, further comprising the step of ranking the agents who submitted candidates.

9. The method of claim 8, wherein a subset of the plurality of agents are blocked from receiving the posting based upon the ranking.

10. The method of claim 8, wherein the ranking is based upon the quality of the candidate submitted by the agent as measured against the characteristics posted.

11. The method of claim 1, further comprising the step of sending an email to agents notifying the agents that a new job has been posted.

12. The method of claim 11, wherein the email includes the amount of the fee and the characteristics sought.

13. A method of finding employment for a candidate, comprising the steps of
a. reviewing posts of positions stored in a database, the posts listing characteristics sought for an employee;
b. matching the characteristics to a candidate's abilities, the candidate having a database entry in a database;
c. notifying the candidate that the candidate's abilities match a post;
d. submitting the candidate through a network to a seeker such that the candidate's database entry is presented to the seeker; and
e. collecting a fee set forth in the post after the candidate becomes an employee of the seeker.

14. The method of claim 13, wherein the characteristics are minimum qualifications.

15. The method of claim 14, further comprising the step of verifying the candidate meets the minimum qualifications.

16. The method of claim 15, further comprising the step of certifying that the candidate was not submitted to the agent by another agent to whom the fee was specified.

17. The method of claim 13, further comprising the step of ranking the posting agent who submitted candidates.

18. The method of claim 17, wherein a posting agent is blocked from posting based upon the ranking.

19. The method of claim 18, wherein the ranking is based upon the responsiveness of the posting agent.

20. A system for matching candidates with an employment opportunity, comprising:
a. a seeker interface configured to receive and post a fee amount and characteristics of an employment opportunity that is viewable to a plurality of agents; and
b. an agent interface configured to search the posted employment opportunities and submit candidates who meet the characteristics of the employment opportunity;
c. wherein the posted fee is paid to an agent through the agent interface when the agent submits a candidate that becomes employed by the seeker.

21. The system of claim 20, wherein the agent is an executive recruiter.

22. The system of claim 20, further comprising an innovator interface such that a user of the system may act as both a seeker and an agent.

23. The system of claim 22, wherein the agent is a human resources employee of a company whose primary business purpose is not placing candidates into employment.

24. The system of claim 23, wherein the submitted candidate initially sought employment at the company of the human resources employee.

25. The system of claim 20, wherein the characteristics are minimum qualifications.

26. The system of claim 25, further comprising a verification tool configured to require the agent to verify the candidate meets the minimum qualifications.

27. The system of claim 26, wherein the verification tool is further configured to require the agent to certify that the candidate was not submitted to the agent by another agent to whom the fee was specified.

28. The system of claim 20, further comprising a ranking module configured to rank the agents who submitted candidates.

29. The system of claim 28, wherein a subset of the plurality of agents are blocked from receiving the posting based upon the ranking of the subset of the plurality of agents.

30. The system of claim 28, wherein the ranking is based upon the quality of the candidate submitted by the agent as measured against the characteristics posted.

31. A method for facilitating human resource exchanges using a plurality of computer resources between employee agents and employee seekers, comprising:
a. presenting a hyper-media screen for an agent to create an employee candidate record retained in a candidate database responsive to an electronic request made by said agent;
b. presenting a selected set of employee positions from a database of available positions responsive to a request made via a hyper-media input screen by said agent;
c. linking said inputted employee candidate record with a selected employee position responsive to a request made via a hyper-media input screen by said agent;
d. sending a signal to said seeker that a linking has occurred;
e. presenting a candidate record screen to said seeker responsive to an electronic request so that said seeker can evaluate said employee candidate; and,
f. sending an electronic notification to said agent of acceptance of said candidate responsive to inputs made by said seeker on a hyper-media screen.

32. The method as recited in claim 31, further including the step of altering a prior posted hiring service fee associated with a prior entered employee position responsive to inputs made by said seeker on a hyper-media input screen.

33. The method as recited in claim 32, further including the step of prior to said candidate record linking step sending an electronic notification to an employee candidate represented by said prior entered candidate record to obtain authorization for linking of said employee record to said employee position.

34. The method as recited in claim 31, further including the step of prior to said candidate record linking step sending an electronic notification to an employee candidate represented by said prior entered candidate record to obtain authorization for linking of said employee record to said employee position.

35. The method as recited in claim 31, further including the step of recording a validation state for credentials listed in said employee candidate record responsive to inputs made by said agent on a hyper-media input screen.

36. The method as recited in claim 35, further including the step of altering a prior posted hiring service fee associated with a prior entered employee position responsive to inputs made by said seeker on a hyper-media input screen.

37. The method as recited in claim 36, further including the step of altering a prior posted employee credentials associated with a prior entered employee position responsive to inputs made by said agent on a hyper-media input screen.

38. The method as recited in claim 31, further including the step prior to said step of presenting a selected set of employee positions to said agent of sending an electronic notification announcement of an employee position to said agent.

39. The method as recited in claim 38, further including the step of prior to said candidate record linking step sending an electronic notification to an employee candidate represented by said prior entered candidate record to obtain authorization for linking of said employee record to said employee position.
